(19) United States
(12) Patent Application Publication
(10) Pub. No.: US 2025/0058409 A1
(43) Pub. Date: Feb. 20, 2025

(54) LASER PROCESSING SYSTEM

(71) Applicant: TRUMPF Laser GmbH, Schramberg (DE)

(72) Inventor: Martin Huonker, Dietingen (DE)

(21) Appl. No.: 18/937,060

(22) Filed: Nov. 5, 2024

Related U.S. Application Data
(63) Continuation of application No. PCT/EP2023/059475, filed on Apr. 12, 2023.

(30) Foreign Application Priority Data
May 6, 2022 (DE) 10 2022 111 262.4

(51) Int. Cl. B23K 26/03; B23K 26/70

(52) U.S. Cl. CPC B23K 26/032; B23K 26/703

(57) ABSTRACT

A laser processing system includes a laser device, at least one processing and/or scanner optic, at least one laser light cable with plug connections, and a cooling circuit comprising a cooling device. The cooling circuit passes through at least the processing and/or scanner optic and the plug connections of the at least one laser light cable. A diorganopolysiloxane circulates in the cooling circuit as a coolant.

### CROSS REFERENCE TO RELATED APPLICATIONS

This application is a continuation of International Application No. PCT/EP2023/059475 (WO 2023/213505 A1), filed on Apr. 12, 2023, and claims benefit to German Patent Application No. DE 10 2022 111 262.4, filed on May 6, 2022. The aforementioned applications are hereby incorporated by reference herein.

### FIELD

Embodiments of the present invention relate to laser processing systems equipped with a cooling device.

### BACKGROUND

During laser processing, heat is generated at various locations in a laser processing system. Even in the laser device itself, the laser beam is guided through optical lenses and generates heat that needs to be dissipated. For precise material processing, it is also important to keep the temperature of processing and scanner optic constant to avoid material expansion of these optics and thus shifts of focus points. Heat is also generated at plug connections between laser light cables, which can lead to material expansion and thus beam changes. Laser processing systems are therefore equipped with a cooling device, which usually has a water cooling circuit. However, in various industrial environments, for example in the production of batteries for electric vehicles, the use of water as a cooling medium for processing optics and connectors of laser light cables is not possible because even small water leaks can lead to serious damage of components or systems.

As an alternative to water, cooling liquids based on ethylene glycol can also be used as coolants. However, these cannot be used in all industrial environments due to their flammability. Ethylene glycol also has hygroscopic properties. Therefore, it cannot be ruled out that this coolant will become enriched over time with water diffused in from the ambient air.

An alternative to cooling with liquid coolants is cooling with compressed air. However, switching to a cooling concept based on compressed air would mean a redesign of the components to be cooled. The cooling channels of the optics and plug connections of laser light cables of existing laser processing systems are not designed, in terms of their cross-sections or their courses, for the ideally required pressure level of air or gas cooling. Especially in the case of plug connections of laser light cables, a relatively large amount of heat needs to be dissipated in a very small installation space. However, the cross-section of the cooling channels is so small that, especially at high laser powers, sufficient cooling medium can basically only be passed through the component using liquid cooling.

### SUMMARY

Embodiments of the present invention provide a laser processing system. The laser processing system includes a laser device, at least one processing and/or scanner optic, at least one laser light cable with plug connections, and a cooling circuit comprising a cooling device. The cooling circuit passes through at least the processing and/or scanner optic and the plug connections of the at least one laser light cable. A diorganopolysiloxane circulates in the cooling circuit as a coolant.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser processing system with a common cooling circuit for all components according to some embodiments; and

FIG. 2 shows a schematic representation of a separate cooling circuit for optical components of a laser processing system according to some embodiments.

### DETAILED DESCRIPTION

Embodiments of the present invention provide a laser processing system in which reliable cooling of the optical components of the system is afforded under all operating conditions.

According to some embodiments, a laser processing system includes a laser device, at least one processing and/or scanner optic, at least one laser light cable with plug connections, and a cooling circuit which passes through or projects into at least the processing and/or scanner optic and the plug connections of the at least one laser light cable, and in which a diorganopolysiloxane circulates as a coolant.

Diorganopolysiloxane or silicone oil does not contain any water, but is hydrophobic. In addition, diorganopolysiloxanes are chemically inert, non-corrosive, nonflammable, non-electrically conductive, nontoxic, and compatible with all common construction materials and sealing materials. Other positive properties include its high temperature resistance and a very low freezing point. Silicone oils with various viscosities are also available. These properties enable it to be used as a cooling liquid for almost all laser processing tasks, with the exception of the processing of workpieces that are later to be coated with paint, for example in car body construction.

Changes to existing processing or scanner optic or to the connectors of laser light cables are not necessary. The cooling efficiency is higher than when using compressed air. In addition, the use of diorganopolysiloxane as a coolant is cheaper than using compressed air.

In principle, it is possible to use the cooling circuit with diorganopolysiloxane also to cool the laser device. Preferably, however, a separate cooling water circuit can be provided for cooling the laser. This makes it easy to retrofit existing systems that already use water cooling. All that is required is to set up a separate cooling circuit with diorganopolysiloxane for the optical components. The water cooling of the laser can remain. The separate cooling circuit can be formed by a cooling device and lines leading to and from the optical components, namely the processing and/or scanner optic with plug connections, of the laser processing system, whereby the lines are firmly connected to the optical components. If the optical components are replaced, the leaks that inevitably occur when the cooling circuit is opened occur in the area of the cooling device and not in the area of the optical components.

Further advantages arise if the diorganopolysiloxane has a viscosity which is similar or identical to that of water. In this case, using a cooling device designed for water creates comparable flow conditions for the coolant.

To make it easier to detect leaks in the cooling circuit, a UV-luminescent dye can be added to the diorganopolysiloxane. By irradiating with UV light, a leak can be found very quickly.

The schematic drawing illustrates the two different cooling concepts.

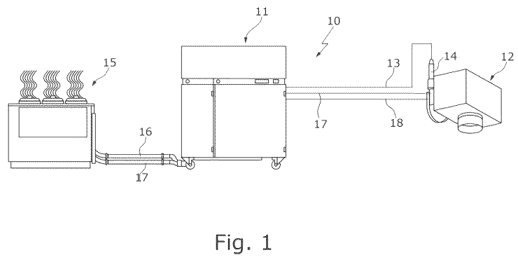

The laser processing system 10 shown in FIG. 1 has a laser device 11 which is equipped with at least one laser (not shown) for providing laser radiation. Furthermore, a processing and/or scanner optic 12 is provided, which is connected to the laser device 11 via a laser light cable 13 and a plug connection 14. A processing optic is a device that directs a processing beam to a workpiece, a scanner optic is a device that directs a scanning beam to a workpiece for monitoring a processing process. It is understood that, in an analogous manner, several processing and/or scanner optics 12 can be connected to the laser device 11. The laser device 11 is cooled via a cooling device 15, which is connected to the laser device 11 via a coolant inlet 16 and a coolant return 17. However, the cooling device 15 not only cools the laser device 11 but also the processing and/or scanner optic 12 and the plug connection 14 via a supply line 17 and a return line 18 between the laser device 11 and the processing and/or scanner optic 12. This means that a single cooling circuit is provided for all components, namely laser device 11, processing and/or scanner optic 12, and laser light cable connector or connector 14 of the laser processing system 10. According to embodiments of the invention, a diorganopolysiloxane circulates in this cooling circuit as a coolant instead of the cooling water usually used to cool laser processing systems.

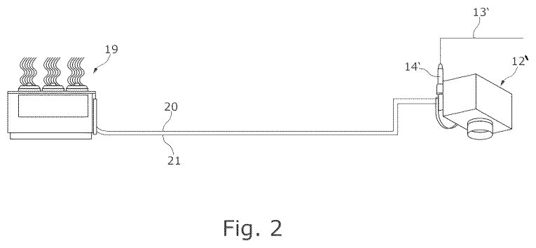

Alternatively, the laser device 11 can be cooled as usual with cooling water and additionally a separate cooling device 19 with diorganopolysiloxane can be provided as a coolant, as shown in FIG. 2. The separate cooling device 19 is connected via a supply line 20 and a return line 21 to a processing and/or scanner optic 12′ and a plug connection 14′ for a laser light cable 13′, and thus cools them independently of a laser device which is not shown in FIG. 2 but is connected via the laser light cable 13′ to the processing and/or scanner optic 12′. The alternative shown in FIG. 2 is suitable for retrofitting existing systems. The cooling of the laser device 11 does not need to be changed. Only the supply and return lines 17, 18 (FIG. 1) are removed and a separate cooling device 19 is installed with diorganopolysiloxane as coolant for the processing and/or scanner optic 12′ and the plug connection 14′.

When converting to cooling with diorganopolysiloxane, it is important to ensure that the cooling channels of the processing and/or scanner optic 12′ and the plug connection 14′ are thoroughly flushed with dry air to completely remove any remaining water from the cooling channels. In addition, diorganopolysiloxane-cooled processing and/or scanner optics 12′ should be kept separate from water-cooled optics in the event of repairs, or should be kept separate so that no silicone oil is transferred to optics that are subsequently used for processing tasks in which the workpieces need to be free of grease and oil.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser processing system comprising:
a laser device,
at least one processing and/or scanner optic,
at least one laser light cable with plug connections, and
a cooling circuit comprising a cooling device, which passes through at least the processing and/or scanner optic and the plug connections of the at least one laser light cable, wherein a diorganopolysiloxane circulates in the cooling circuit as a coolant.

2. The laser processing system according to claim 1, wherein the cooling device of the cooling circuit is configured to also cool the laser device.

3. The laser processing system according to claim 1, wherein the cooling circuit further comprises:
a second cooling device configured to cool only the processing and/or scanner optic with the plug connections of the laser processing system, and
lines leading back and forth from the second cooling device to the processing and/or scanner optic with the plug connections, wherein the lines are firmly connected to the processing and/or scanner optic with the plug connections.

4. The laser processing system according to claim 1, wherein the diorganopolysiloxane has a viscosity that corresponds to a viscosity of water.

5. The laser processing system according to claim 1, wherein a UV-luminescent dye is added to the diorganopolysiloxane.

6. A cooling circuit having a cooling device in a laser processing system according to claim 1.
